(19) United States
(12) Patent Application Publication
(10) Pub. No.: US 2004/0026463 A1
(43) Pub. Date: Feb. 12, 2004

(54) Dispensing device

(76) Inventor: Pentti Airaksinen, Oulu (FI)

Correspondence Address: YOUNG & THOMPSON, 745 SOUTH 23RD STREET 2ND FLOOR, ARLINGTON, VA, 22202

(21) Appl. No.: 10/344,234

(22) PCT Filed: Aug. 14, 2001
(86) PCT No.: PCT/FI01/00715

(30) Foreign Application Priority Data
Aug. 15, 2000 (FI) 20001801

(51) Int. Cl. B67D 3/00

(52) U.S. Cl. 222/529

(57) ABSTRACT

A dispensing device especially for dispensing colour paste comprises a container (1) for storing the colour paste, a pump (3) connected to the container (1), a nozzle pipe (9), and a valve which connects the pump (3) to the container (1) and to the nozzle pipe (9). The valve comprises a valve enclosure (5), a valve element (4) arranged to move in a reciprocating manner in it, and a seat connected to the nozzle pipe (9). An elastic sealing (7) is attached to the valve element (4) for providing a return movement of the valve element after the nozzle pipe (9) has been closed by a percussion-like movement of the valve element (4).

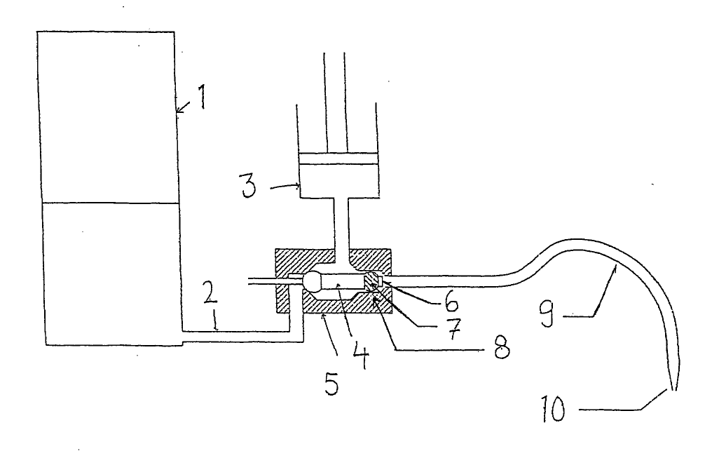

### FIELD OF THE INVENTION

The invention relates to a dispensing device according to the preamble of claim 1.

There are two main principles in dispensing colour paste. In one principle, a pump based on admission and outward strokes is used. Such a pump usually has as a valve a sliding slide having a small inner volume. In some cases, different poppet valve modifications are also used as the valves. In the second principle, a continuous-yield pump based on gears or the like combined with a poppet- or slide-type three-way valve is used. In both principles, a big problem arises from the fact that the dispensed paste remains at the tip of the nozzle as an indeterminate drying and dirtying drop. When paste dries and accumulates in the nozzles, it hinders the flow of the paste and causes significant errors in dispensing. A lump of colour paste forming at the tip of the nozzle has a tendency to change its shape and size as a result of drying and accumulation in an entirely unpredictable manner. This results in serious operational disturbances in the machine, imprecision, complaints, device failures and extra maintenance visits. In addition to the drying problem, all pastes also change as a result of long storage times, mixing, pumping, settling and separation.

The drying of colour paste at the mouth of a nozzle has in plunger pumps been prevented with different closing mechanisms, one of which is disclosed in U.S. Pat. No. 5,042,699. In closing mechanisms, the tip of a nozzle is typically closed air-tight, in which case the colour paste remaining in the nozzle cannot dry. These mechanisms are, however, typically difficult to manufacture and service due to the movement of the nozzles. Some machines are controlled by program to make the machine suck the colour paste back in to the nozzle, but being a slow action, this cannot prevent the nozzle tip from dirtying due to creeping caused by surface tension. Blocking nozzles can, in addition to dispensing errors, in the worst case damage an automatic machine.

Several techniques for the actual removal of the drop are known, but it is typical of all of them that the flow is formed by drops and does not comply with the purpose of use of toning machines, in which the largest doses may be several litres at a time. Ink-jet printers, paint sprayers, diesel motor nozzles or precision dispensers of the medical industry are examples of dispensing using drops. A pulsating pump equipped with at least one anti-siphonage valve is usually used in precision dispensers, as disclosed in U.S. Pat. No. 5,743,960, for instance. In the dispensing pump of said publication, a vertically reciprocating valve is opened and closed at a predefined rate to make the dispensed liquid dribble as drops. In the disclosure, the dispensing pump is located at the tip of the nozzle pipe, because in designing precision dispensers, the general starting point is to minimize the liquid volume between the nozzle tip and the dispensing pump. In practice, such structures have produced very slow and inaccurate results. Because the pump is small in relation to the container and the dispensing is to be done from a very limited space to a canister, the natural structure of the machines is of a certain type. This is why the machines have for long been built based on peripherally mounted pumps dispensing one at a time or simultaneously dispensing pumps mounted in the centre. In these machines, the aim is to make said liquid volume as small as possible. In practice, the dispensing precision has, however, not been as required. A small paste volume has often led to an even poorer result than a bigger one. This phenomenon has not been correctly interpreted, which has up till now prevented the improvement of precision. In addition, the structure of the machines has made space utilization very poor.

### BRIEF DESCRIPTION OF THE INVENTION

It is thus an object of the invention to provide a dispensing device in which the above problems have been solved. The object of the invention is achieved by a device which is characterized by what is stated in the independent claim. Preferred embodiments of the invention are disclosed in the dependent claims.

The device of the invention has a decidedly better precision than conventional designs in that, contrary to earlier solutions, a sufficiently large liquid volume has been provided between the nozzle tip and the pump. The emptying of colour paste from the nozzle tip has been enhanced by an elastic sealing structure of the valve, which causes siphonage of the colour paste to the nozzle pipe from the tip of the nozzle. When a percussion-like closing movement is provided in the valve, the elastic sealing structure causes the valve element to a backward movement after the impact, and on the other hand, a pressure wave caused by the percussion-like movement in the nozzle pipe cuts the colour paste at the tip of the nozzle. This way, the nozzle is kept clean and the colour paste is prevented from drying in the nozzle. The fact that the nozzle keeps clean increases dispensing precision on one hand and minimises maintenance needs caused by the drying of the colour paste on the other. The device is characterized by very precise dispensing both at full doses of the pump and at very small dose amounts. In addition, the device provides the advantage that it can be kept internally operational for long periods of time without any external action by the user.

### BRIEF DESCRIPTION OF THE FIGURES

In the following, the colour paste dispensing device of the invention will be described in greater detail with reference to the attached drawing, the FIGURE in which shows a sketch of a dispensing device of the invention.

### DETAILED DESCRIPTION OF THE INVENTION

Using the reference numerals of the FIGURE, the dispensing device of the invention comprises a container 1, in which a colour paste is kept. The container 1 is connected through a suction pipe 2 to a pump 3, by means of which the colour paste is sucked, dispensed and fed out of the container 1. The pump 3 is typically a displacement plunger pump, as shown in the figure, and its shaft is substantially vertical. The dispensing pump 3 of the FIGURE comprises a dispensing cylinder and inside the cylinder, a displacement element arranged to move in a reciprocating manner, which in the following will be referred to as a plunger regardless of whether this element is moved by a plunger rod or a bellows-type element. The plunger pump can alternatively be replaced by a gear pump, in which case in addition to the actual suction pipe a discharge pipe is added to the device, through which the colour paste can be re-circulated between the pump and the container. In this case, a valve assembly is typically located in connection with the pump, discharge pipe and nozzle pipe.

A nozzle pipe 9 is connected to the pump 3 for feeding out the colour paste doses. The nozzle pipe 9 is preferably made of an elastic material, such as plastic, and it is sufficiently long to assist in the propagation of the pressure wave in the pipe. The free end of the nozzle pipe 9 has a nozzle part 10 which controls the flow of the colour paste being fed out. A valve for controlling the correct direction of movement of the colour paste during the different steps of dispensing is located in connection with the container 1, plunger pump 3 and nozzle pipe 9. The valve thus has two operating positions, one for connecting the plunger pump to the suction pipe 2 and the other for connecting it to the nozzle pipe 9.

The valve assembly comprises a valve element 4, a valve enclosure 5 and a seat (not marked by a reference numeral) to the nozzle pipe 9, and when pressing against the seat, the valve element 4 closes the connection to the nozzle pipe 9. The valve is located in such a manner that, when the valve element 4 closes the connection to the nozzle pipe 9, its movement is substantially parallel with the flow direction of the colour paste through the valve element 4 to the nozzle pipe 9. The head of the valve element 4 comprises preferably a percussion plug 6 which fits in a plunger-like manner inside the seat and which, when the valve is being closed, causes a sharp impact towards the seat and nozzle pipe 9. The plunger-like operation of the valve element can also be implemented without the percussion plug by a suitable construction of the valve element and seat. The valve element 4 is at its nozzle pipe 9 end also equipped with an elastic sealing 7, the elasticity of the sealing being sufficient to make the valve element 4 spring back after impacting with the seat connected to the nozzle pipe 9. The valve enclosure 5 is preferably shaped so that the end part 8 of the open space at the nozzle pipe 9 end is cylindrical and arranged to receive the valve element 4 with its sealing 7 and percussion plug 6 pushing into it. The thus achieved constriction improves the percussion function of the valve.

The device of the invention provides a precise dispensing through the nozzle 10 so that no extra colour agent remains at the tip of the nozzle to cause a dispensing error or need for maintenance. This is done in such a manner that an intentional pressure impact is caused by the valve element 4 to the colour paste being dispensed by the plunger at the end of dispensing, this causing the jetting of the paste from the nozzle 10 and the detachment of the drop so that no indeterminate drop of paste remains at the tip of the nozzle. The pressure impact is done by the valve element 4 percussion plug 6 closing in the direction of the paste flow and it is enhanced by the constriction of the flow against the cylindrical enclosure 5 of the valve generated by the nozzle-side end of the valve element 4. When the valve is closed, the percussion plug 6 of the valve element 4 moves rapidly towards the seat. At the same time, the percussion plug 6 pushes paste in front of it in the direction of the dispensing flow. When the percussion plug 6 hits the seat, the paste continues to flow within the limits of the elasticity provided by the sealing, pipe and flowing paste. When the flow stops in a pulse-like manner, the liquid column rushing from the nozzle is cut neatly aided by surface tension. On the other hand, the liquid column remaining in the pipe 9 and nozzle 10 draws back into the nozzle to the extent of the spring-back force provided by the sealing 7 of said element 4. This way, the colour paste remains slightly inside the nozzle 10 and does not dirty the tip of the nozzle. Thus, a sufficient volume between the tip of the nozzle 10 and the pump 3 is essential for said operation. Said phenomenon is especially useful in a plunger pump when at the end of the dispensing, the rate of the dispensing plunger can be slowed down and nearly stopped. This also provides a good dispensing precision for very small doses.

The phenomenon of the invention occurs only when the nozzle tip is open when the valve closes, contrary to U.S. Pat. No. 5,042,699 which discloses a nozzle closing device which prevents this function and efficiently eliminates the occurrence of the phenomenon described in this invention. The nozzle pipe connecting the valve and the nozzle tip should also be long and elastic enough for the pressure wave generated by the percussion plug to propagate in the pipe. This property is missing from the invention of U.S. Pat. No. 5,743,960, in which the dispensing pump is located at the end of the nozzle pipe and the pressure wave required to cut the paste cannot be generated.

Because the suction side 2 of the valve is always open when the nozzle pipe 9 is closed, this property can be utilised efficiently in flushing the valve, cylinder and suction pipe. This is done by merely moving the plunger back and forth, whereby a fresh colour paste flowing from the container flushes said structures keeping them clean without requiring any user action. This decidedly improves the usability of the device in dispensing easily drying and solidifying colour pastes and also ensures a continuous dispensing precision. The described flushing property can also be utilised in cleaning the container.

It is obvious to a person skilled in the art that while technology advances, the basic idea of the invention can be implemented in many different ways. The invention and its embodiments are thus not restricted to the examples described above, but can vary within the scope of the claims.

1. A dispensing device especially for dispensing colour paste, the device comprising
a container (1) for storing the colour paste,
a pump (3) connected to the container (1) for the suction, dose setting and feeding out of colour paste doses,
a nozzle pipe (9) for feeding out the colour paste doses, and
a valve which is connected to the container (1), pump (3) and nozzle pipe (9) and which has two operating positions, one for connecting the pump (3) to the container (1) and the other for connecting it to the nozzle pipe (9), and which comprises a valve enclosure (5), a valve element (4) arranged to move in a reciprocating manner in it, and a seat connected to the nozzle pipe (9), against which the valve element (4) is arranged to press in a plunger-like manner and to then close the connection to the nozzle pipe (9), in which case the movement of the valve element (4) when it closes the connection to the nozzle pipe (9) is substantially parallel with the flow direction of the colour paste through the valve enclosure (5) to the nozzle pipe (9), characterized by an elastic sealing (7) attached to the valve element (4) for providing a return movement of the valve element after the nozzle pipe (9) has been closed by a percussion-like movement of the valve element (4).

2. A dispensing device as claimed in claim 1, characterized in that the structure of the nozzle pipe (9) is elastic, which assists the propagation of a pressure wave in the nozzle pipe.

3. A dispensing device as claimed in claim 1 or 2, characterized by a constriction (8) between the elastic sealing (7) and the valve enclosure (5) at the nozzle pipe (9) end of the valve enclosure (5) to enhance the plunger-like operation of the valve element (4).

4. A dispensing device as claimed in claim 3, characterized in that the constriction (8) is created by the cylindrical shape of the valve enclosure (5) at the nozzle pipe (9) end of the valve enclosure (5).

5. A dispensing device as claimed in any one of claims 1 to 4, characterized in that the pump is a plunger pump.

6. A dispensing device as claimed in any one of claims 1 to 5, characterized in that the head of the valve element (4) comprises a percussion plug (6) which fits in a plunger-like manner inside the seat.
